(19) United States
(12) Patent Application Publication
(10) Pub. No.: US 2006/0260944 A1
(43) Pub. Date: Nov. 23, 2006

(54) METHOD AND APPARATUS FOR DIELECTROPHORETIC SEPARATION

(75) Inventors: Marc J. Madou, Irvine, CA (US); Benjamin Y. Park, Irvine, CA (US); Alan C. Paradiso, Irvine, CA (US)

Correspondence Address: Vista IP Law Group LLP, 9th Floor, 2040 Main Street, Irvine, CA, 92614, US

(73) Assignee: The Regents of the University of California, Oakland, CA (US)

(21) Appl. No.: 11/419,144

(22) Filed: May 18, 2006

Related U.S. Application Data
(60) Provisional application No. 60/682,562, filed on May 19, 2005.

(51) Int. Cl. B03C 5/02

(52) U.S. Cl. 204/643; 204/547

(57) ABSTRACT

A dielectrophoretic separation device includes a chamber including an inlet and an outlet disposed between the inlet and the outlet. A plurality of three dimensional electrodes are disposed in within the chamber. The electrodes may take the form of a wire or semi-cylindrical conductors disposed on a substrate. At least some of the electrodes include smooth surfaces so as to create an electric field (in response to an applied alternating current) that has a low strength in a region disposed away from the electrodes and an electric field having a high fields strength in a region between adjacent electrodes. Particulate matter or other species experiencing a positive DEP force may be separated and collected in the gaps or regions formed between adjacent electrodes.

### REFERENCE TO RELATED APPLICATIONS

This Application claims priority to U.S. Provisional Patent Application No. 60/682,562 filed on May 19, 2005. U.S. Provisional Patent Application No. 60/682,562 is incorporated by reference as if set forth fully herein.

### STATEMENT REGARDING FEDERALLY SPONSORED RESEARCH AND DEVELOPMENT

The U.S. Government may have a paid-up license in this invention and the right in limited circumstances to require the patent owner to license others on reasonable terms as provided for by the terms of Grant No. DMI-0428958 awarded by the National Science Foundation.

### FIELD OF THE INVENTION

The field of the invention generally relates to methods and devices that use electrodes for creating an electric field gradient for dielectrophoretic separation processes. The field of the invention further relates to shaping of three-dimensional (“3D”) electrodes such that the fluid flow surrounding the 3D electrodes is highly correlated to the generated electric field gradient.

### BACKGROUND OF THE INVENTION

In dielectrophoresis (DEP), the difference of polarizability between a particle in a solution subject to a non-uniform electric field gives rise to a net force acting on the particle. In positive dielectrophoresis, particles that are more polarizable than the solution and tend to move toward high-field regions. In contrast, in negative dielectrophoresis, particles that are less polarizable than the solution migrate toward low electrical field regions. Because particles respond differently to an applied electrical field (e.g., an AC-based electrical field), particles can be separated or sorted by creating a field gradient in a solution. For example, if a frequency is chosen where particle A exhibits positive DEP and particle B exhibits negative DEP, the particles can be separated by creating a field gradient. Particles of type A would be attracted to the high field regions, and particles of type B would be attracted to low field regions.

Dielectrophoresis has the advantage of being able to apply forces onto uncharged species (such as, for example, cells or carbon nanotubes) by the induction of a dipole in both the uncharged species and surrounding solution. The difference between the dipole of the species and the surrounding solution creates a force on the particle which can be harnessed for separation. Separation using DEP has been demonstrated, but because the DEP force decays rapidly as the distance from typical planar electrode arrays increases, there have been difficulties in creating high throughput separation devices. There is a problem, however, with existing DEP-based separation devices because many require high voltages to effectuate particle separation. Still other devices are limited in their operation because of the quick decay of the DEP force from commonly used planar electrodes. Other devices involve difficult fabrication processes such as etching through a wafer or the use of transparent conductors.

3D electrodes can extend the electric field into the solution and are able to effectively increase the volume of separation. However, even when using 3D electrodes, it is difficult to create a high efficiency separation device because of the difficulty of washing away only certain particles.

DEP separation techniques may be particularly useful in the field of tribology (lubrication). For example, researchers estimate that a large percentage of all machine failures are due to wear. The abnormal abrasive wear due to lubricant contamination in marine diesel engines, for example, eclipses that of normal wear and the gap becomes wider with time. It has been found that although oil filters used in automotive engines are designed to filter particles in the 15-30 μm range, particles with diameters below 10 μm are believed to cause about 44% of the wear to engine cylinders. Physical filters that are currently used are limited because of difficulties in decreasing pore size, and the associated flow restrictions that follow when pore size is reduced. Unlike conventional filter technology, application of dielectrophoretic forces allows manipulation of small particles, even in the submicron range.

There thus is a need for a device and method wherein DEP electrodes can produce an electric field gradient such that particle sorting or separation can take place. The device should be able to be integrated into flow cells, cartridges, or a housing such that small particles can be separated from a flowing solution. There is also a need for DEP separation device where the electric field can be propagated throughout the fluid volume to permit high throughput without the need for high voltages. The method and device would advantageously allow the separation of selected particles or components in a mixture.

### SUMMARY OF THE INVENTION

In a first aspect of the invention, a DEP separation device includes a chamber or housing that includes an inlet and an outlet. A separation zone is disposed between the inlet and the outlet. A plurality of three-dimensional electrodes are located in the separation zone wherein at least some of the electrodes include smooth surfaces so as to create an electric field having low field strength in a region disposed away from the electrodes and an electric field having high field strength in a region between adjacent electrodes. The device further includes a source of alternating current coupled to the electrodes.

In one aspect of the invention, the plurality of three-dimensional electrodes is formed from electrodes having a semi-cylindrical shape (semi-circular in cross-section). In addition, in certain embodiments, the electrodes may be formed in an interdigitated manner with a spacer separating adjacent electrodes.

In another aspect of the invention, a DEP separation device includes a chamber or housing having an inlet and an outlet with a separation zone disposed between the inlet and the outlet. A plurality of elongate conductors are disposed in the separation zone and are arranged generally parallel to one another. At least some of the elongate conductors include smooth surfaces so as to create an electric field having a low field strength in a region disposed away from the electrodes and an electric field having a high field strength in a region between adjacent electrodes. A source of alternating current is coupled to the plurality of elongate conductors. In one aspect, the elongate conductors may comprise wires.

In one preferred aspect of the invention, the plurality of elongate conductors are arranged generally perpendicular to the direction of fluid flow within the housing or chamber. In an alternative embodiment, the elongate conductors may be arranged generally parallel to the direction of fluid flow. In still other embodiments, the elongate conductors may be arranged at an angle with respect to fluid flow—for example if the elongate conductors are arranged in a spiral manner.

The separation device may have one or more detectors positioned between adjacent conductors. The detector provides added functionality to the filtering/separation device. The detector may detect the presence or absence of a particular analyte or species within the fluid passing through the device. Alternatively, the detector may detect one or more parameters such as, for example, pH.

In yet another aspect of the invention, a DEP separation device includes a chamber having an inlet and an outlet and a separation zone disposed between the inlet and the outlet. A first conductor is spirally wound within the separation zone. A second conductor is also spirally wound within the separation zone. The second conductor is disposed adjacent to the first conductor along at least a portion of the separation zone. A source of alternating current is coupled to the first and second conductors. In one embodiment, the first and second conductors are spiral wound around a support member or mandrel that is positioned within the chamber. The conductors may comprise electrically conductive wires.

In another aspect, the device described above includes an insulator disposed between the first conductor and the second conductor in the separation zone. For example, the insulator or spacer may be interwoven with the first and second conductors. Like the prior device, one or more detectors may be disposed or located between adjacent first and second conductors.

### BRIEF DESCRIPTION OF THE DRAWINGS

FIG. 1A illustrates a computer simulation of the electric field present in de-ionized water (DI) in which two planar electrodes have been placed. A voltage of +/−30V was applied to the electrodes.

FIG. 1B illustrates a computer simulation of the electric field present in de-ionized water (DI) in which two 50 μm high three-dimensional electrodes have been placed. A voltage of +/−30V was applied to the electrodes.

FIG. 2A illustrates the electric field distribution |E| of a three-dimensional semicircular electrode design. The plane shown is the vertical plane. The diameter of the electrodes was 400 μm and the distance between adjacent electrodes was 100 μm. Voltages of +/−5 V were applied to the electrodes.

FIG. 2B illustrates the velocity field (m/s) of the electrode configuration shown in FIG. 2A.

FIG. 3 illustrates a method of forming electrodes for a DEP separation device according to one aspect of the invention.

FIG. 4 illustrates a method of forming electrodes for a DEP separation device according to another aspect of the invention.

FIG. 5A illustrates a top down plan view of an interdigitated electrode array according to one embodiment of the invention.

FIG. 5B illustrates a side view of a filter device incorporating the electrode array configuration of the type disclosed in FIG. 5A.

FIG. 5C illustrates a cross-sectional view of the filter device of FIG. 5B taken along the line A-A. The interconnect electrodes and voltage generator are also illustrated.

FIG. 5D illustrates a side view of an interdigitated electrode array having insulative spacers disposed therein according to one embodiment.

FIG. 5E illustrates a side view of an interdigitated electrode array having an insulative spacer disposed therein according to another embodiment.

FIG. 6A illustrates a DEP filtration device according to another embodiment of the invention.

FIG. 6B illustrates a magnified view of a portion of a spiral electrode assembly according to one embodiment of the invention.

FIG. 7 illustrates a graph showing the particle count of oil collected from a DEP separation device of the type disclosed in FIGS. 6A and 6B. Standard deviation bars are shown. Particle size was not taken into account.

### DETAILED DESCRIPTION OF THE INVENTION

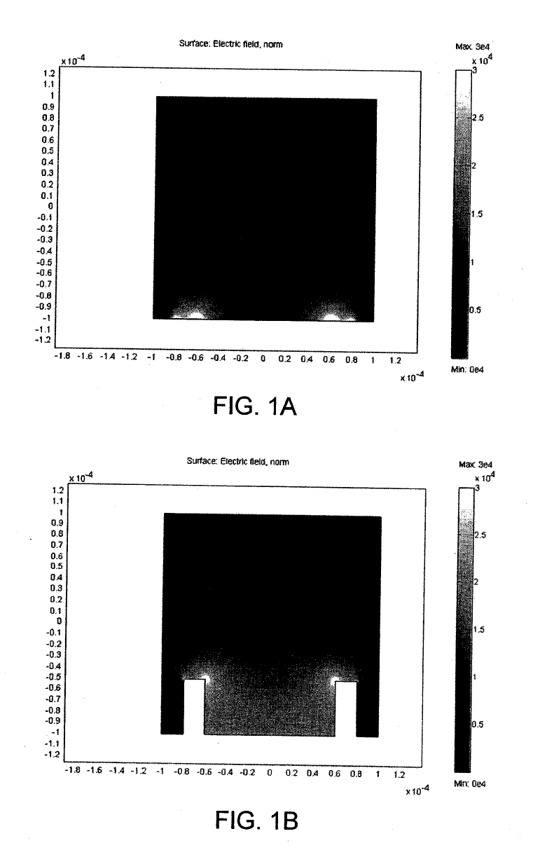

FIG. 1A graphically illustrates the results of a computer simulation of the electric field present in de-ionized water (DI) in which two planar electrodes have been placed. The modeled electrodes had diameters of 50 μm and a center-to-center distance of 140 μm. A voltage of +/−30V was applied to the electrodes. As seen in FIG. 1A, the electric field generated by the electrodes is concentrated at or near the planar electrodes. The electric field is, however, relatively weak or low between the adjacent electrodes.

Although there has been some success in particle separation using planar electrodes, most designs have suffered from the problem of low throughput. The problem with traditional methods of using planar microelectrodes is that the DEP force, which is proportional to ∇|R|², rapidly decays as the distance from the planar electrodes increases. This is one of the limitation that has prevented dielectrophoresis from being widely used in high volume applications. There have been attempts in the past of using screens, conducting plates, and microfabricated filters for effective flow-through particle separators, but most designs require either application of high voltages (due to the distance between the electrodes) or involve complex fabrication techniques (such as requiring multiple substrates involving transparent Indium Tin Oxide (ITO) electrodes for visual feedback or requiring bulk micromachining).

FIG. 1B illustrates a computer simulation of the electric field present in de-ionized water (DI) in which two 50 μm high three-dimensional electrodes have been placed. The modeled electrodes had diameters of 50 μm and a center-to-center distance of 140 μm. The simulation was run with an applied voltage of +/−30V across the electrodes. As seen in FIG. 1B, the electric field remains relatively low or weak in the region disposed away from the electrodes (the top portion of FIG. 1B). However, unlike the planar electrode configuration illustrated in FIG. 1A, a region of high or concentrated electric field intensity is located between the adjacent electrodes. The present invention harnesses this feature to trap or retain species such as particulate matter. In this regard, the methods and devices described herein may be used to filter particulate matter (or other matter) from a flowing fluid.

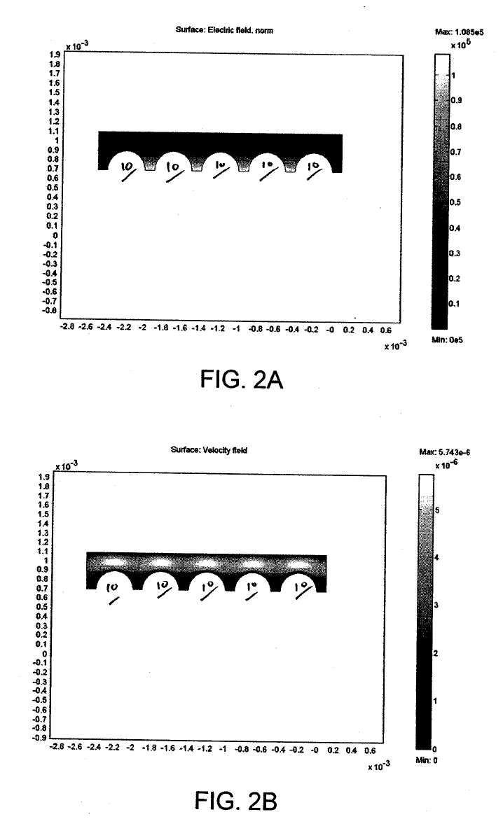

FIG. 2A illustrates the simulated electric field surrounding a plurality of three-dimensional electrodes 10. A cross-sectional view is shown taken along the vertical plane passing through the electrodes 10. According to one aspect of the invention, the electrodes 10 are formed with a smooth exterior surface. For example, the electrodes 10 may be formed with a semi-cylindrical shape (semi-circular in cross section) as is shown in FIGS. 2A and 2B. The electrodes 10 may be formed on a substrate (not shown) that immersed or otherwise placed in a fluidic environment. The electrodes 10 may have a length such that the electrodes 2 are exposed to a larger volume of fluid. For example, the electrodes 10 may be formed as long semi-cylindrical electrodes that are placed in close proximity to one another. In the embodiment shown in FIG. 2A, each adjacent electrodes has a different polarity. The electrodes 10 illustrated in FIG. 2A have diameters of 400 μm. The distance between adjacent electrodes 10 is 100 μm. Voltages of +/−5 V were applied to the electrodes 10.

As seen in FIG. 2A, a strong electric field is formed in the regions between adjacent electrodes 10 (the white portions between electrodes 10). In contrast, the region disposed away from the electrodes 10 (the dark portions located away from the electrodes 10) has a relatively low or weak electric field. FIG. 2B illustrates the simulated flow velocity field (m/s) of the same electrodes 10 shown in FIG. 2A. In contrast to the electric field distribution, the velocity is the highest in the region located away from the electrodes 10 (white portion in FIG. 2B). In contrast, the flow velocity is low or weak the regions between adjacent electrodes 10. In the configuration shown in FIGS. 2A and 2B, electrical field strengths will be lowest near smooth surfaces and highest near sharp edges as well as the locations where the electrodes 10 are closer together. A particle (or other species) that exhibits positive dielectrophoresis at a given frequency will be attracted to the narrow spaces between the semi-cylindrical electrodes 10. This feature can be leveraged to filter out particulate matter or other species from a fluid. The fluid may be static above the electrodes 10 or, in preferred embodiments, flowing over the surface of the electrodes 10. Those particles or species that are not attracted to the high field strength regions between adjacent electrodes 10 (e.g., those particles experience no or negative DEP) may be eluted via a flowing fluid passing over the electrodes 10.

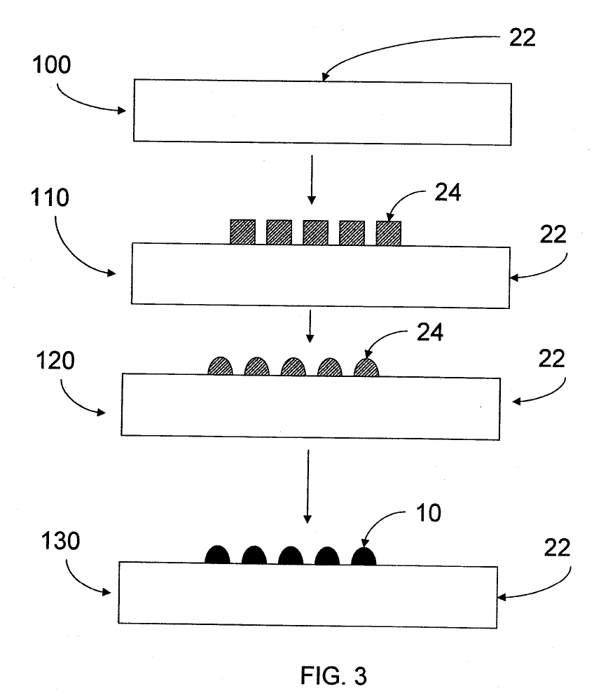

FIG. 3 illustrates one method of creating a DEP separation electrodes 10 using Carbon MicroElectroMechanical Systems (C-MEMS) microfabrication techniques. The method may be used to form the long, semi-cylindrical electrodes 10 of the type disclosed in FIGS. 2A and 2B. Referring to FIG. 3, in step 100, a non-conductive substrate 22 is provided. The substrate may be formed, for example, from SiO₂ on a silicon wafer. Next, in step 110, a pattern or mold of a polymer 24 is formed on the substrate 22. For example, the polymer 24 may be a photoresist such as SU-8 negative photoresist that is patterned directly onto the substrate 22. Different polymers 24 may be molded or otherwise deposited on the substrate 22. The polymer 24 may be patterned on the substrate 22 using photolithography, molding, silk-screening, or other known technique.

If the polymer 24 is a photoresist material, it is then allowed to harden or solidify by baking or curing at around 95° C. Next in step 120, if a photoresist material is used as the polymer 24, the polymer 24 is heated so that the polymer 24 begins to flow or partially flow. By flowing the polymer 24, the polymer 24 takes on the smooth, semi-cylindrical shape. If molding or silk-screening are used to deposit the polymer 24, the electrodes 10 may already be in a suitable shape thereby obviating the need to “flow” the polymer 24.

Referring now to step 130, the polymer 24 is then pyrolyzed into carbon-based electrodes 10 by heating the same in an oven or the like at an elevated temperature sufficient for pyrolysis to occur (e.g., around 1000° C.) in an inert atmosphere (e.g., Nitrogen or forming gas). In an alternative method to that described above, after step 120 (or in lieu of), a mold (not shown) could be used to form the smooth shapes of the electrodes 10. The mold may be used, for example, to mold metallic materials.

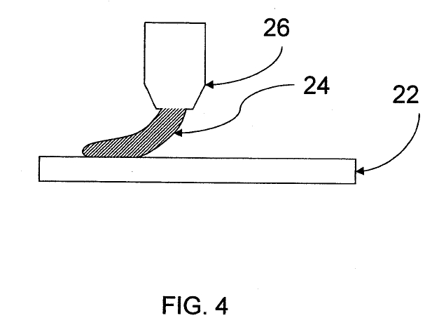

FIG. 4 illustrates yet another method of forming electrodes 10 for a DEP separation device. As seen in FIG. 4, molten metal or a polymer 24 is deposited (e.g., squeezed) from a nozzle 26 or delivery device onto the substrate 22. Either the substrate 22 and/or the nozzle 26 can be moved to create the line or pattern. If a polymer 24 was patterned, then a pyrolysis step may be needed to convert the polymer 24 into carbon-based electrodes 10.

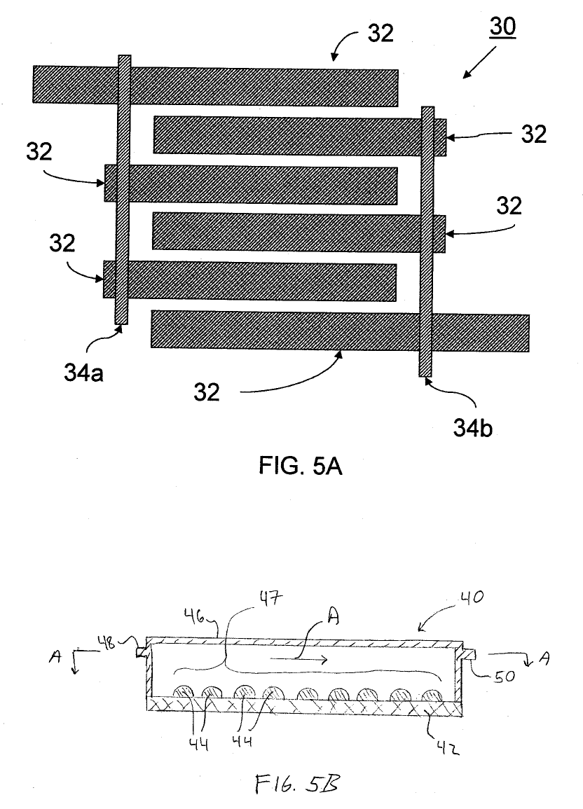

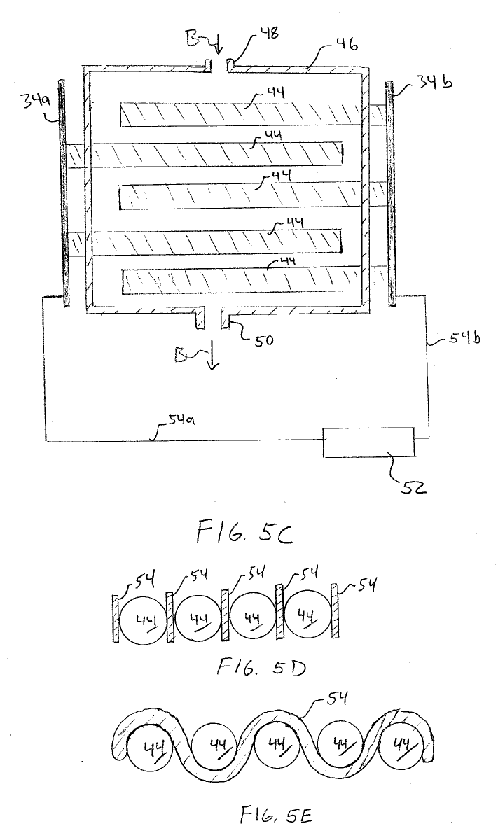

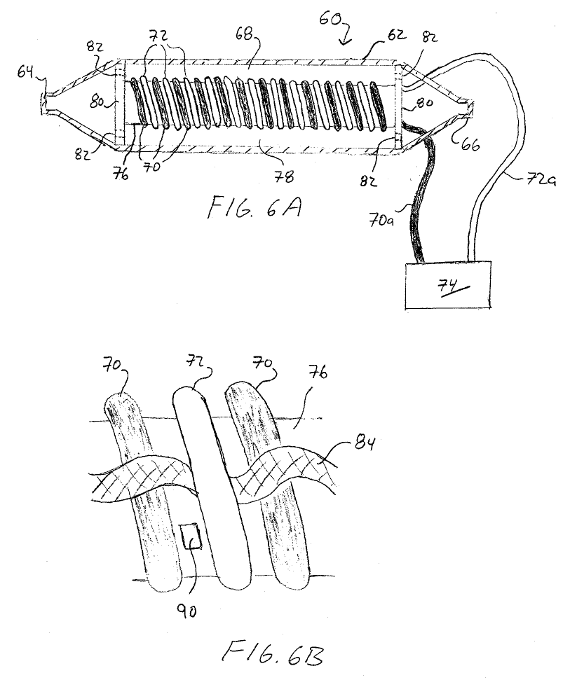

FIG. 5A illustrates a top down plan view of an interdigitated electrode array 30. The electrode array 30 includes a plurality of individual electrodes 32. The electrodes 32 may be formed as the long semi-cylindrical electrodes 32 described above. The electrode array 30 includes interconnect conductors 34a, 34b or wires that are used to connect the electrodes 32 to a alternating current (AC) current source (not shown in FIG. 5A). The interconnect conductors 34a, 34b are connected to the electrodes 32 in such a manner that adjacent electrodes 32 are connected to different interconnect conductors 34a, 34b.

FIG. 5B illustrates a cross-sectional side view of a DEP separation device 40 according to one embodiment of the invention, the DEP separation device 40 includes a substrate 42 having a plurality of three-dimensional electrodes 44 disposed thereon. The electrodes 44 are connected to a source of alternating current (not shown). For example, interconnect conductors of the type illustrated in FIG. 5A may be used. The electrodes 44 may be formed as an interdigitated array such as that described above with respect to FIG. 5A.

The three-dimensional electrodes 44 include smooth surfaces and may be formed, for example, as long semi-cylindrical electrodes 44. The DEP separation device 40 includes a chamber 46 that encloses the three-dimensional electrodes 44. A separation zone 47 is created generally above where the three-dimensional electrodes 44 are formed. Particles experiencing a positive DEP force in the separation zone 47 are attracted to the regions of high electric field strength located between adjacent electrodes 44.

The chamber 46 includes an inlet 48 and an outlet 50 such that fluid can pass into and out of the DEP separation device 40. For example, fluid (not shown) may pass from the inlet 48 into the interior of the chamber 46. The fluid then flows over the electrodes 44 in the direction of arrow A in FIG. 5B. Fluid flow continues until the fluid exits the chamber 46 via outlet 50. Of course, the device 40 may include multiple inlets 48 and outlets 50.

The electrodes 44 may be oriented generally perpendicular to the direction of flow. Alternatively, in other embodiments the electrodes 44 may be angled or oriented parallel to the direction of flow. Generally, it is preferred that the flow velocity field be designed such that it is highly correlated to the electric field gradient. In this regard, the device is able to separate particulates or other contaminants (or other species) more efficiently.

In the embodiment shown in FIG. 5B, particulate matter (or other species) contained in the fluid may be separated by application of an AC current to the electrodes 44. Those particles or other species that experience a positive DEP force will be drawn from the fluid toward the regions located between adjacent electrodes 44 (i.e., the high electric field regions). As AC current is applied, those particles or other species will accumulate in the region adjacent to the electrodes 44. Consequently, the device 40 acts as a separation device or filter. Particles or other species that do not experience a positive DEP force will remain in the fluid away from the electrodes 44. These particles can then be eluted from the device 40 by the flow of fluid out of the outlet 50.

The alternating current source used in connection with the DEP separation device 40 may be adjusted to control what species or particles are attracted to the regions between adjacent electrodes 44. For example, the applied frequency may be altered to control what species are separated or filtered out of the fluid. Typically, particles may be separated from the fluid using voltages less than 250 VAC.

As explained in more detail below, one or more optional spacers (not shown in FIG. 5B) may be disposed between adjacent electrodes 44. The spacers serve to separate the adjacent electrodes 44 from one another by a uniform distance. Also, the spacers prevent an accidental short circuit between adjacent electrodes. The spacers may be permanent or temporary (e.g., sacrificial). Of course, spacers may not be needed at all if the electrodes 44 formed on the substrate are formed using lithographic, molding, silk-screening, or other processes that accurately place electrodes 44 on a substrate 42.

FIG. 5C illustrates a top cross-sectional view of the DEP separation device 40 illustrated in FIG. 5B. FIG. 5C also illustrates the interconnect conductors 34a, 34b that are connected to the electrodes 44. The interconnect conductors 34a, 34b are connected to a source of alternating current 52 via wires 54a, 54b or the like. The source of alternating current 52 may include a pulse/function generator. For example, one exemplary source of alternating current 52 is the HP 8111A pulse/function generator which is available from Hewlett-Packard, Palo Alto, Calif. Preferably, the source of alternating current 52 may be such that the applied frequency can be altered. The source of AC current 52 may also involve a current-limiting voltage source to prevent short circuits. The source of alternating current 52 may need to be amplified by a high voltage amplifier (not shown). For instance, the AMS-1B30 high voltage bipolar amplifier available from Matsusada Precision, Inc., of Shiga, Japan may be used. As shown in FIG. 5C, fluid flows generally in the direction of the arrows B. In this regard, fluid flow enters the device 40 via the inlet 48 and exits the device 40 via the outlet 50. The inlet 48 and/or outlet 50 may be connected to conduits such as flexible tubing or the like (not shown). Flow may be initiated through the device by the use of one or more pumps (not shown). In certain applications, like those in the field of tribology, the pump may comprise an lubricating pump such as, for instance, an oil pump.

With reference now to FIGS. 5D and 5E, the electrodes 44 used in the DEP separation device 40 may include one or more spacers 54 positioned between adjacent electrodes 44. In the embodiment shown in FIG. 5D, multiple separate spacers 54 are placed in between adjacent electrodes 44. The spacers 54 are preferably formed from an insulative material In addition, the spacers 54 are positioned in only a portion of the gap between adjacent electrodes 44. In this regard, ample space between the electrodes 44 is available for particle (or species) accumulation during DEP activation.

In the embodiment shown in FIG. 5E, a single flexible spacer 54 is interwoven or wrapped around the electrodes 44. The thickness of the spacer 54 will determine the magnitude of the electric field and the decay of the field gradient for a certain voltage. Thinner gaps between the electrodes 44 is advantageous, but there is a possibility of shorting due to the close proximity of the electrodes 44. Because of this, in the case of wire-based electrodes 44, it may be advantageous to make the electrode wires 44 short so that the flexing of the wires 44 is minimized.

FIG. 6A illustrates a DEP separation device 60 according to another embodiment of the invention. The DEP separation device 60 includes a chamber or housing 62 that includes an inlet 64 and an outlet 66. The chamber 62 includes an interior compartment 68 through which fluid flows during operation of the device 60. Still referring to FIG. 6A, a first conductor 70 in a spiral wound configuration is positioned within the interior compartment 68 of the chamber 62. A second conductor 72 also in a spiral wound configuration is positioned within the interior compartment 68 of the chamber 62. The first and second conductors 70, 72 are wound in an alternating fashion. Namely, adjacent spiral windings alternate (in the longitudinal direction) between first and second conductors 70, 72 as can be seen from FIGS. 6A and 6B. The first and second conductors 70, 72 may be formed from electrically conductive wires, for example, copper wires.

As best seen in FIG. 6A, the first and second spiral wound conductors 70, 72 terminate into leads 70a, 72a that exit the chamber 62. The leads 70a, 72a then connect to an alternating current source 74. In FIGS. 6A and 6B, the first and second conductors 70, 72 are spiral wound around a support member 76 or mandrel. The support member 76 provides a base on which the first and second conductors are wound 70, 72. The support member 76 or mandrel is preferably solid such that fluid passing through the chamber 62 must traverse the separation zone or region 78 formed between the spiral windings 70, 72 and the interior surface of the chamber 62.

The support member 76 or mandrel may be fixedly secured to the interior of the chamber 62. For example, as one illustrative embodiment, the support member 76 may be secured to two cross members 80 formed at either end of the chamber 62. The cross members may include a number of holes or apertures 82 to permit the passage of fluid. It should be understood the support member 76 may also be integrated with the chamber 62 itself. Alternatively, the support member 76 may float freely within the confines of the interior of the chamber 62.

In still another alternative embodiment of the invention, the support member 76 may be omitted entirely. In still another embodiment, the first and second spiral conductors 70, 72 may be spiral wound to back track on each other to form nested spiral wound coils. This embodiment has the advantage of increasing the overall surface area for separation. In still another alternative configuration, the first and second spiral conductors 70, 72 may be wound alongside an interior surface of the chamber 62. In addition, the spiral windings 70, 72 may take on a variety of shapes or geometries including circular windings, oval windings, polygonal windings, and the like.

FIG. 6B illustrates the spiral windings of first and second conductors 70, 72 according to another embodiment of the invention. In this embodiment, a spacer 84 is woven around the windings of the first and second conductors 70, 72. The spacer 84 is preferably formed from an insulative material. The spacer 84 may be permanent or sacrificial. In addition, one or more spacers 84 (only one of which is shown in FIG. 6B) may be used to properly space the windings of the first and second conductors 70, 72. Still referring to FIG. 6B one or more optional detectors 90 (one of which is illustrated in FIG. 6B) may be positioned in the region between adjacent windings of the first and second conductors 70, 72. The detector 90 may detect an operational parameter such as, for instance, pH. The detector 90 may also detect the presence or absence of certain analytes or species within a solution. For example, using bound ligands or monoclonal antibodies, the detector 90 may detect the presence of a biological material or cell within the fluid. As one example, the detector 90 may include a binding moiety that binds to cancer cells. Blood may then be passed through the device 60. The presence of cancer cells may be detected using the detector 90.

During operation of the DEP separation device 60, a fluid is passed through the DEP separation device 60. For example, the fluid may comprise oil that contains particulate matter (i.e., contaminants). An alternating current is applied to the first and second conductors 70, 72 using the alternating current source 74. Typically the voltage applied is less than 250 VAC. Particulate matter or other species that experience a positive DEP force are then attracted to the spaces or gaps formed between adjacent turns of the first and second conductors 70, 72. The clean (or cleaner) fluid is then able to pass out of the DEP separation device 60 via the outlet 66.

A test DEP separation device of the type disclosed in FIGS. 6A and 6B was constructed to test the spiral electrode, flow through design. The spiral-electrode designs were fabricated by wrapping two long wires wrapped the around a wooden centerpiece. Copper wires (16 AWG) were used, but most of the experiments were performed using steel welding wire (14 AWG gauge of approximately 1.6 mm in diameter). The electrodes were spaced apart by threading a microbore plastic tubing (FISHER Catalog No. 14-170-15A 0.010W) between the wires. The entire electrode assembly was inserted into a polyethylene drying tube with end cap connections (FISHER Catalog No. 09-242A). Additional details on the experimental test may be found in the following publication entitled “A Novel Dielectrophoretic Oil Filter,” by B. Park et al., Proc. IMechE Vol. 220 Part D: J. Automobile Engineering (November 2005) which is incorporated by reference as if set forth fully herein.

The design spiral configuration has the following advantages: (1) sealing of the system was easier in the tubular design, (2) the problem of creating electrical interconnects to every other electrode was avoided through the use of a spiral design consisting of only two wires, and (3) it was much easier to create devices with more effective separation volume (the volume between the active electrodes).

The experimental setup included a HP 8111A pulse/function generator (available from Hewlett-Packard, Palo Alto, Calif.) that was used to apply the alternative voltage to the electrodes. The setup also included an AMS-1B30 high voltage bipolar amplifier (available from Matsusada Precision, Inc., Shiga, Japan). Fluid (i.e., oil) was introduced in the device using a syringe pump (Harvard Apparatus, USA). Disposable all poly syringes were used (ALDRICH Catalog No. Z24,803-7). Contaminated oil was passed through the device at a rate of 1 mL/min. An AC voltage of 250 Vₚₚ at 5 kHz was applied for the experimental setup. There was some voltage drop during the experiments due to carbon accumulation between the wires. No voltage was applied for the control.

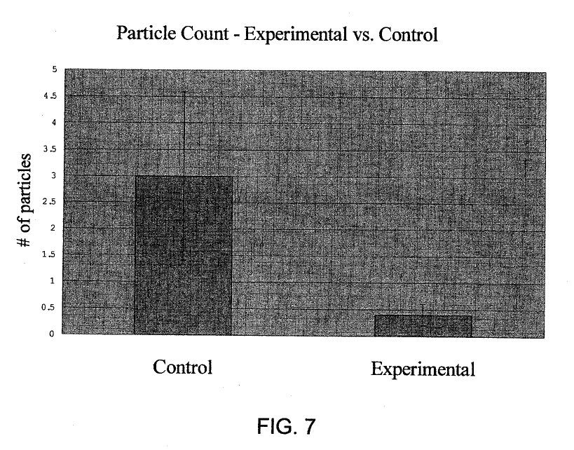

After testing the experimental device as well as the control, there was a marked visual difference between the experimental and the control setup. Namely, the control setup produced noticeably dirtier oil. The contaminant levels of the oil were quantified by looking at a sample of the oil under a microscope. A micropipette was used to drop 5 μl of the oil between two microslides. After waiting for the oil to spread throughout the whole slide, the number of particles visible was counted to distinguish whether the control samples were indeed dirtier then the experimental samples. The slides were observed under a MM micromanipulator probe station with the microscope at 20× (objective lens) and 10× (eyepiece) for a total magnification of 200×. Three different trials were run each for the experimental setup and the control setup. The only difference between the experimental setup and the control was that no voltage was applied for the control. Five random counts were made for each trial and the average was used. The results are shown in FIG. 7. The results indicate that a reduction of up to 90% of particulate contaminants could be achieved (the standard deviation was quite high due to the small number of particles within view and the uneven distribution of particles within the oil). Each observed particle was a clump of smaller nanofibers.

Although the present invention was demonstrated in the field of tribology (lubrication), the invention can be used in any application involving separation, filtration, or concentration of species. For example, the DEP separation devices and methods may be used in the filtration and online monitoring of lubricants. Conductive contaminants such as metal particles from an engine or carbon soot that are suspended in a lubricant (e.g., electrically conductive medium) may be removed using the DEP separation device described herein. For example, the DEP separation device could supplement (or supplant) a physical oil filter in an automobile and trap conductive particles that are too small to be filtered mechanically. The DEP separation device may also be used to separate silica-based contaminants from engine oil depending on the polarizability of the silica. The DEP separation device may also double as an online monitoring system that measures the level of contaminants in a lubricant and provides feedback to the owner of the vehicle so that timely lubricant change operations can be performed. DEP separation may also be used in the separation of carbon nanotubes. Currently, there is no way to grow nanotubes homogeneously. There is great interest in separating semiconducting carbon nanotubes from metallic carbon nanotubes. The DEP devices and methods described herein may also be used in biomedical applications. For instance, DEP devices may be used to separate cells or other biological entities. Separation of viable or diseased cells from the blood stream or from a heterogeneous cell culture or tissue sample can greatly improve the accuracy and sensitivity of diagnostic techniques. For example, separation of viable/diseased cells increases the signal-to-noise ratio for a bio-assay by separating away unwanted variables and it is an amplification technique that allows early detection by concentrating the species of interest.

While embodiments of the present invention have been shown and described, various modifications may be made without departing from the scope of the present invention. The invention, therefore, should not be limited, except to the following claims, and their equivalents.

What is claimed is:

1. A dielectrophoretic separation device comprising:
a chamber including an inlet and an outlet and a separation zone disposed between the inlet and outlet;
a plurality of three-dimensional electrodes disposed in the separation zone, at least some of the electrodes including smooth surfaces so as to create an electric field having low field strength in a region disposed away from the electrodes and an electric field having high field strength in a region between adjacent electrodes; and
a source of alternating current coupled to the electrodes.

2. The device of claim 1, wherein the electrodes are semi-cylindrical electrodes.

3. The device of claim 1, wherein the electrodes comprise pyrolyzed polymer.

4. The device of claim 1, wherein the source of alternating current applies a voltage at or below 250 VAC.

5. The device of claim 1, further comprising a spacer disposed between the plurality of three-dimensional electrodes.

6. A dielectrophoretic separation device comprising:
a chamber including an inlet and an outlet and a separation zone disposed between the inlet and outlet;
a plurality of elongate conductors disposed in the separation zone generally arranged parallel to one another, at least some of the elongate conductors including smooth surfaces so as to create an electric field having low field strength in a region disposed away from the electrodes and an electric field having high field strength in a region between adjacent electrodes; and
a source of alternating current coupled to the plurality of elongate conductors.

7. The device of claim 6, wherein the plurality of elongate conductors comprise wires.

8. The device of claim 6, wherein the plurality of elongate conductors are arranged generally perpendicular to the direction of fluid flow within the chamber.

9. The device of claim 6, wherein the plurality of elongate conductors are arranged generally parallel to the direction of fluid flow within the chamber.

10. The device of claim 6, further comprising at least one detector positioned between adjacent elongate conductors.

11. The device of claim 6, further wherein the source of alternating current is a current-limiting voltage source.

12. The device of claim 6, further comprising a spacer disposed between adjacent elongate conductors.

13. A dielectrophoretic separation device comprising:
a chamber including an inlet and an outlet and a separation zone disposed between the inlet and outlet;
a first conductor spiral wound within the separation zone;
a second conductor spiral wound within the separation zone, the second conductor being disposed adjacent to the first conductor along at least a portion of the separation zone; and
a source of alternating current coupled to the first and second conductors.

14. The dielectrophoretic separation device according to claim 13, wherein the first and second conductors are spiral wound around a support member positioned within the chamber.

15. The dielectrophoretic separation device according to claim 13, wherein the first and second conductors comprise wires.

16. The dielectrophoretic separation device according to claim 13, further comprising a spacer disposed between the first conductor and the second conductor in the separation zone.

17. The dielectrophoretic separation device according to claim 16, wherein the spacer is interwoven with the first conductor and the second conductor.

18. The device of claim 13, further comprising at least one detector positioned in a gap formed between the first and second conductors.
